(19) United States
(12) Patent Application Publication
(10) Pub. No.: US 2023/0322094 A1
(43) Pub. Date: Oct. 12, 2023

(54) EMULATION OF INTERNAL COMBUSTION ENGINE FOR DRIVER OF ELECTRIC VEHICLE

(71) Applicant: Atieva, Inc., Newark, CA (US)

(72) Inventor: Warren van Nus, Fremont, CA (US)

(21) Appl. No.: 18/188,060

(22) Filed: Mar. 22, 2023

Related U.S. Application Data
(60) Provisional application No. 63/269,740, filed on Mar. 22, 2022.

(51) Int. Cl. B60L 15/20

(52) U.S. Cl. CPC B60L 15/20; B60L 2240/14; B60L 2250/16; B60L 2250/26

(57) ABSTRACT

A computer-implemented method comprises: receiving, by an electric vehicle (EV), a user selection of a first vehicle type from among multiple vehicle types each having an internal combustion engine, the user selection made with regard to an emulation operation mode of the EV; receiving, by the EV and with the first vehicle type selected for the emulation operation mode, a first input made by a driver using an accelerator pedal of the EV, the first input associated with a first acceleration of the EV with the emulation operation mode inactive; and in response to the first input and while the emulation operation mode being active, providing the EV with a second acceleration determined based on the first vehicle type and the first input.

### CROSS-REFERENCE TO RELATED APPLICATION

This application claims benefit, under 35 U.S.C. § 119, of U.S. Provisional Patent Application No. 63/269,740, filed on Mar. 22, 2022, entitled “EMULATION OF INTERNAL COMBUSTION ENGINE FOR DRIVER OF ELECTRIC VEHICLE”, the disclosure of which is incorporated by reference herein in its entirety.

### TECHNICAL FIELD

This document relates to emulation of an internal combustion engine for the driver of an electric vehicle.

### BACKGROUND

In recent years, the world’s transportation has begun a transition away from powertrains primarily driven by fossil fuels and toward more sustainable energy sources, chiefly among them electric motors powered by on-board energy storages. An electric vehicle (EV) is typically quieter than an internal combustion engine (ICE) vehicle. Some EVs have powertrains that generate considerably more torque, particularly at lower speeds, than typical ICE vehicles.

### SUMMARY

In a first aspect, a computer-implemented method comprises: receiving, by an electric vehicle (EV), a user selection of a first vehicle type from among multiple vehicle types each having an internal combustion engine, the user selection made with regard to an emulation operation mode of the EV; receiving, by the EV and with the first vehicle type selected for the emulation operation mode, a first input made by a driver using an accelerator pedal of the EV, the first input associated with a first acceleration of the EV with the emulation operation mode inactive; and in response to the first input and while the emulation operation mode being active, providing the EV with a second acceleration determined based on the first vehicle type and the first input.

Implementations can include any or all of the following features. Providing the EV with the second acceleration comprises emulating an acceleration of the first vehicle type. Emulating the acceleration of the first vehicle type comprises applying an acceleration reduction to the EV. Emulating the acceleration of the first vehicle type comprises taking into account at least one characteristic of the first vehicle type selected from the group consisting of: rotational inertia, transmission gearshifts, turbocharger rotation speed, boost control, anti-lag control, launch control, or a blow-off valve. Emulating the acceleration of the first vehicle type comprises emulating gearshifts of the first vehicle type. Emulating the acceleration of the first vehicle type comprises applying at least the first input to a model corresponding to the first vehicle type. The computer-implemented method further comprises emulating, on a display device of the EV, an instrument cluster of the first vehicle type. The computer-implemented method further comprises emulating, using a speaker of the EV, a sound of the first vehicle type. The sound of the first vehicle type includes a motor sound. The sound of the first vehicle type includes a non-motor sound. The computer-implemented method further comprises receiving a second input in the EV, and applying the second input in emulating the first vehicle type. The second input includes a gearshift request made using a hardware control of the EV, and wherein applying the second input in emulating the first vehicle type comprises adjusting the second acceleration based on the second input. The first vehicle type is a track vehicle. The first vehicle type is a non-road vehicle. The computer-implemented method further comprises capping the second acceleration by the first acceleration at least once. The second acceleration is capped by the first acceleration in response to a magnitude of the second acceleration exceeding a limit. The second acceleration is based on a scaling of an acceleration capability of the first vehicle type. Providing the EV with the second acceleration comprises changing a torque crossover.

In a second aspect, an electric vehicle (EV) comprises: a selection control to receive a user selection of a first vehicle type from among multiple vehicle types each having an internal combustion engine, the user selection made with regard to an emulation operation mode of the EV; an accelerator pedal to generate, with the first vehicle type chosen for the emulation operation mode, a first input made by a driver of the EV, the first input associated with a first acceleration of the EV with the emulation operation mode inactive; and a model to provide the EV, while the emulation operation mode is active and using a powertrain of the EV, with a second acceleration determined based on the first vehicle type and the first input.

Implementations can include any or all of the following features. The EV further comprises a display device, wherein the model outputs an image that emulates an instrument cluster of the first vehicle type. The EV further comprises a speaker, wherein the model outputs audio that emulates a sound of the first vehicle type. The EV further comprises a hardware control for the driver to make a gearshift request, wherein the model adjusts the second acceleration based on the gearshift request. The model has inputs including acceleration pedal input, gearshift requests, and vehicle state, and wherein the model generates outputs including a longitudinal acceleration target, sound, and driver metrics. The second acceleration is capped by the first acceleration at least once. The second acceleration is capped by the first acceleration in response to a magnitude of the second acceleration exceeding a limit.

In a third aspect, an EV comprises: a selection control to receive a user selection of a first vehicle type from among multiple vehicle types each having an internal combustion engine, the user selection made with regard to an emulation operation mode of the EV; a powertrain; and means for emulating, using the powertrain and while the emulation operation mode is active, an acceleration of the first vehicle type without exceeding an associated acceleration of the EV.

### BRIEF DESCRIPTION OF DRAWINGS

FIG. 1 shows an example of an emulation controller that can be used with an electric vehicle (EV).

FIG. 2 shows an example of an instrument panel of an EV.

FIG. 3 shows a diagram of an EV acceleration capability encapsulating the acceleration capability of ICE vehicles.

FIG. 4 schematically shows an example block diagram of an EV.

FIG. 5 schematically shows an example block diagram of a model for emulating at least acceleration of an ICE vehicle.

FIG. 6 shows an example of a vehicle audio system that can emulate sounds of an ICE vehicle.

FIG. 7 shows an example of a method.

FIG. 8 shows an example of a system that can perform emulation in an EV.

FIG. 9 shows an example of an architecture for performing emulation in an EV.

FIG. 10 schematically shows emulation of torque crossover.

FIG. 11 shows examples of scaling in an emulation.

FIG. 12 illustrates an example architecture of a computing device that can be used to implement aspects of the present disclosure.

Like reference symbols in the various drawings indicate like elements.

### DETAILED DESCRIPTION

This document describes examples of systems and techniques for an EV to emulate one or more aspects of an ICE vehicle (e.g., its acceleration). This can allow the driver of the EV to enjoy a convincing experience of a different powertrain than that of the EV. An EV can be characterized in that it provides a near-silent operation and a smooth, powerful acceleration (both due to its electric powertrain). For example, the EV can provide an “emulation operation mode” where the EV selectively and dynamically reduces the torque output by its powertrain to simulate that of an ICE vehicle. This can be referred to as providing a “virtual powertrain.” Optionally, the EV can also emulate the instrument visuals and/or audio of the ICE vehicle. As such, the present subject matter can add character to an EV, make it an even more engaging and exciting option, and improve its appeal with a widening range of car enthusiasts.

When the driver selects an emulation operation mode, the EV can automatically and seamlessly simulate the powertrain of a selected ICE vehicle, based on driver inputs and state inputs of the EV. The EV can dynamically limit the torque output of its powertrain to match the ICE vehicle’s acceleration output according to a model. In some implementations, a convincing auditory experience tailored to the selected ICE vehicle can be provided. In some implementations, the EV can provide relevant metrics to the driver (e.g., by emulating one or more dials or other instrumentation devices of the ICE vehicle).

A model used as part of an emulation operation mode can be designed with a goal of facilitating an emulation that matches the acceleration of the modeled ICE vehicle, with the restriction that the torque is dynamically limited. For functional safety, the EV emulating an ICE vehicle should not implement a torque greater than what the EV itself would generate in the same situation, with the emulation operation mode deactivated. As such, the goal of the model may be to replicate the acceleration of the model ICE vehicle, not merely duplicating its motor torque or its axle torque. That is, the emulation operation mode may aim to emulate the feeling and the forces of acceleration of the ICE vehicle. To do so, the model can scale for one or more real aspects or characteristics of the EV, including, but not limited to, its vehicle mass, or its voltage or state of energy (SoE). When the EV driver presses on the accelerator of the EV, the unfiltered torque demand corresponding to the accelerator depression, and the emulated vehicle acceleration calculated by the model (e.g., a value measured in meters per square second (m/s²)), can be subjected to one or more comparisons. Thereafter, the filtered torque demand that is output to a controller of the EV can then be the lesser of the model-generated torque request or the unfiltered torque demand from the EV driver. That is, with the emulation operation mode being active the EV can filter torque demands via an onboard model to limit output torque to replicate the longitudinal acceleration of a particular ICE powertrain, and such torque output can be scaled to take into account (e.g., compensate for) differences in weight between the EV and the ICE vehicle.

The model that emulates a particular ICE can be provided by a company that currently or in the past manufactured the ICE vehicle. For example, the model specific to a particular type of ICE vehicle can then be offered as a licensed version. In some implementations, a generic version of an emulated ICE vehicle can be provided. For example, such a model can replicate the acceleration performance of the powertrain of that ICE vehicle in a generic fashion.

The emulation operation mode, which may be implemented using software and/or hardware components of the EV, can be installed in the EV during manufacturing, or it can be added to the EV later (e.g., at the driver’s request). For example, an over-the-air software update can be provided via a wireless communication channel to install the emulation operation mode, or to add one or more new emulation models to choose between. A specific type of ICE vehicle can be added to the emulation operation mode either as part of a group of emulation vehicle types, or individually (e.g., upon request).

In some implementations, a manufacturer of EV powertrain components can offer the emulation operation mode as a product or service among others. For example, the emulation operation mode can be sold (e.g., licensed for conditional use) together with an EV drive unit and/or an EV battery pack that the manufacturer is making available for purchase.

For a vehicle manufacturer, the present subject matter can facilitate an easier transition into modern and more sustainable products. Some vehicle manufacturers that are well known for their legacy of ICE vehicles have developed a faithful group of enthusiastic customers that remain loyal to the company’s vehicle types and to their particular performance, sights, and sounds. When such legacy manufacturers contemplate adding EVs to their range of offerings, they sometimes have concerns that these loyal customers may not feel comfortable or familiar with the markedly different experience of driving an EV. However, the present subject matter can provide such would-be EV manufacturers the option of offering an emulated version of the company’s legacy ICE vehicle as part of the newly introduced EV. As such, a car enthusiast who is predisposed toward the legacy ICE vehicles of Company “X” can now be offered to buy a newly introduced EV from Company “X” that retains the feel, and optionally the looks or sound, of its legacy ICE vehicles. The use, in an EV, of sounds emulating an ICE may be readily acceptable to such car enthusiasts because a number of today’s ICE performance cars already provide artificial and/or augmented motor sounds in the passenger cabin. In addition to catering toward the brand loyalty of its existing customers, the emulation operation mode can allow the legacy ICE-vehicle manufacturer to profile its EVs against the EVs of other companies.

In some implementations, when a specific type of ICE vehicle on the market is not readily available for testing, the present subject matter can allow a presumptive purchaser of the ICE vehicle to “test drive” its performance and get a feeling for its driving characteristics. In such scenarios, the EV equipped with emulation operation mode can serve to emulate a great number of ICE vehicles, thereby offering an unmatched flexibility is testing and comparing an essentially endless number of possibilities.

The emulation of the ICE vehicle is not limited to its acceleration or other powertrain characteristics. In some implementations, any of multiple visual and/or audible aspects of the ICE vehicle can be emulated. Such aspects can include, but are not limited to, the appearance of an instrument cluster, the sound of the ICE, or any other (non-motor) sound generated by the ICE vehicle.

Implementations of the present subject matter can include advantages such as, but not limited to, the following. A unique value can be provided to an EV for car enthusiasts that may historically have favored ICE vehicles. For an EV manufacturer, an after-sale revenue stream can be provided by installing the emulation operation mode and/or by adding new ICE vehicle types to be emulated. An EV manufacturer can secure the opportunity to provide exclusive incentives to certain customers (e.g., as a loyalty program). An EV manufacturer can provide its EVs with a tactile and exciting feature that is easily marketable. EVs can be provided with a flexible and tailored “personality.”

Examples herein refer to a vehicle. A vehicle is a machine that transports passengers or cargo, or both. A vehicle can have one or more motors using at least one type of fuel or other energy source (e.g., electricity). As used herein, an EV is a vehicle that does not have an ICE used for propulsion of the EV. Examples of vehicles include, but are not limited to, cars, trucks, buses, track vehicles, or non-road vehicles (e.g., aircraft). The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples herein refer to display devices. A display device visually outputs a graphical user interface for one or more computer devices. A display device can operate according to any of multiple display technologies used for presenting computer-based information. A display device can include a liquid crystal display (LCD), a light-emitting diode (LED) display, and/or a plasma display, to name just a few examples. A display device can be configured for receiving input for the computer device(s). In some implementations, a display device can feature one or more types of technology for detecting contact with, or proximity to, the screen by a user’s hand or an implement such as a stylus. A display device can operate according to any of multiple touch-detecting, or gesture-recognizing, technologies. A display device can include a resistive touchscreen, a capacitive touchscreen, and/or a touchscreen based on optical imaging, to name just a few examples. A display device can have any of multiple shapes. In some implementations, a display device has a quadrilateral shape (e.g., rectangular), or a non-polygonal shape, to name just a few examples. A display device can have a substantially flat form factor (e.g., the screen is essentially planar), or a non-flat form factor (e.g., the screen is curved according to one or more radiuses.)

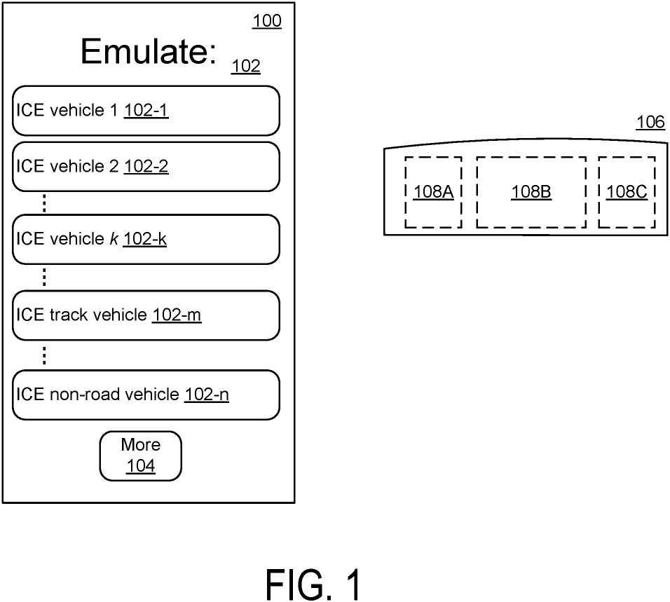

FIG. 1 shows an example of an emulation controller 100 that can be used with an EV. The emulation controller 100 can be used in combination with one or more other examples described elsewhere herein. The emulation controller 100 is a selection control that can generate one or more screens on a display device with which a user (e.g., the driver of the EV) can interact. For example, the display device where the emulation controller 100 is presented can be provided by a mobile electronic device (e.g., a smartphone), or by an instrument panel of the EV.

The emulation controller 100 allows the user to select, for emulation, any of multiple vehicle types having ICEs. Here, ICE selections 102 are made available to the user to choose between. In some implementations, the ICE selections 102 can include multiple types of ICEs intended for land use (e.g., road driving or off-road driving). Here, land-use ICE vehicle types are represented by ICE vehicle selections 102-1, 102-2, ..., 102-k are shown, where k is any integer. For example, each of the ICE vehicle selections 102-1, 102-2, ..., 102-k can be associated with one or more of a model year, a manufacturer name (e.g., brand), a model name, a trim level, or an edition identifier.

In some implementations, the ICE selections 102 can include multiple types of ICEs intended for track use (e.g., an off-highway vehicle). Here, ICE vehicle types for track use are represented by an ICE vehicle selection 102-m, where m represents one or more individual options. For example, the ICτE vehicle selection 102-m can correspond to having the EV emulate a track vehicle, including, but not limited to, a racecar, rally car, oval stock car, or an endurance racing car.

In some implementations, the ICE selections 102 can include multiple types of ICEs intended for non-road use (e.g., an airborne or seaborne vehicle). Here, ICE vehicle types for non-road use are represented by an ICE vehicle selection 102-n, where n represents one or more individual options. For example, the ICE vehicle selection 102-n can correspond to having the EV emulate a non-road vehicle, including, but not limited to, an aircraft or watercraft.

Other approaches can additionally or instead be offered. For example, the emulation controller 100 can provide a control 104 for making additional choices available.

The emulation controller 100 can cause the EV to emulate the acceleration of the ICE vehicle type that the user has selected when activating the emulation operation mode. In doing so, the emulation controller 100 can cap the emulated acceleration by the acceleration that the EV would have if the emulation operation mode were inactive. For example, capping may be performed constantly during emulation, or can be performed only one or more times, such as only when the emulation satisfies one or more criteria (including, but not limited to, that a limit is exceeded).

The emulation controller 100 can emulate one or more aspects of an instrument cluster of the selected ICE vehicle type. In some implementations, the EV can have a display 106 (e.g., mounted in an instrument panels of EV). The display 106 can include one or more individual display devices. In some implementations, one or more of content 108A-108C can be presented on the display 106 during the emulation operation mode. One or more of the content 108A, 108B, or 108C can visually resemble a dial, gauge, meter, or other instrument of the ICE vehicle type’s dashboard. For example, the particular needle, faceplate, and/or bezel appearance of a traditional instrument can be emulated in an operational fashion. For example, the content 108A can present a speedometer, the content 108B can present a pressure gauge, and the content 108C can present a tachometer. Other approaches can be pursued.

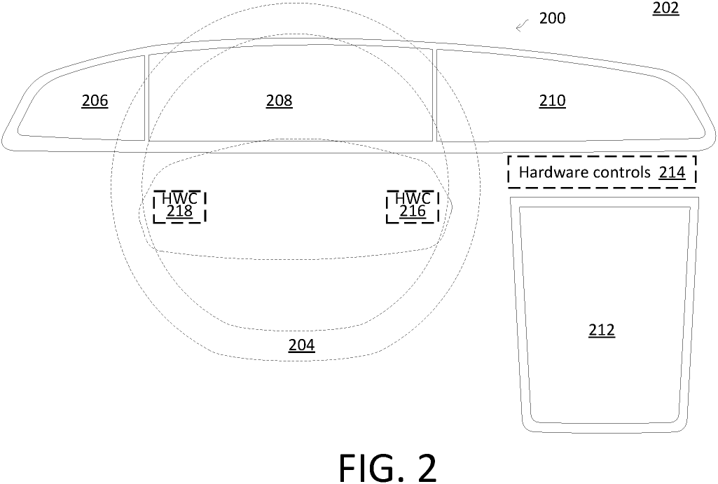

FIG. 2 shows an example of an instrument panel 200 of an EV 202. The EV 202 is mostly omitted in the present illustrations for simplicity. The EV 202 includes a steering wheel 204 (here shown in phantom for clarity), that can be used in connection with, or independently of, one or more controls or functions available at the instrument panel 200. The instrument panel 200 can be used in combination with one or more other examples described elsewhere herein.

The instrument panel 200 can be used for emulating one or more aspects of an ICE vehicle. In some implementations, the instrument panel 200 can emulate an instrument cluster of a selected vehicle type that has an ICE. The emulation can be performed by presenting images of the instrument cluster on a display device of the instrument panel 200. For example, this call allow presentation of one or more relevant metrics to the driver of the EV.

The instrument panel 200 includes a display device 206 here positioned somewhat to the left of the steering wheel 204. The instrument panel 200 includes a display device 208 here positioned essentially behind the steering wheel 204. The instrument panel 200 includes a display device 210 here positioned somewhat to the right of the steering wheel 204. The display device 210 can be horizontally aligned with an instrument cluster in the vehicle 202. For example, the instrument cluster can include at least the display device 208. The instrument panel 200 includes a display device 212 here positioned lower than (e.g., essentially vertically below) the display device 210. The display device 212 is considered to be positioned in the instrument panel 200. For example, the display device 212 can be positioned lower in the same physical housing in which the display devices 206, 208, and 210 are mounted. Presentation of an emulation (e.g., a visual representation) shown or mentioned herein can be made on one or more of the display devices 206, 208, 210, or 212.

An emulation operation mode can be managed using one or more hardware controls in the EV 202. First, the EV driver can use an accelerator pedal (not shown) to generate input that controls the acceleration (e.g., the emulated acceleration) of the EV. Second, one or more other aspects of the emulation operation mode can be controlled by applying an input generated using a hardware control. For example, a gearshift request can be made using a hardware control. Based on such input, the acceleration of the emulation operation mode can be adjusted.

In some implementations, the instrument panel 200 can include one or more buttons, paddles, toggles, scroll wheels, or other physical control devices by which the driver can make at least one input. Here, hardware controls 214 on the instrument panel 200 are schematically represented. The hardware controls 214 can be positioned at any of multiple locations on the instrument panel 200 reachable by the driver of the EV 202. In some implementations, the steering wheel 204 can include one or more buttons, paddles, toggles, scroll wheels, or other physical control devices by which the driver can make at least one input. Here, hardware controls (HWC) 216 and 218 on the steering wheel 204 are schematically represented. In some implementations, one or more of the hardware controls 214, 216, or 218 can be used for making an input (e.g., a gearshift request or selection of emulation vehicle type), and the emulation operation mode can be controlled based on the input. One or more of the hardware controls 214, 216, or 218 can be standard equipment of the EV 202 that is repurposed to generate an emulation input while the emulation operation mode is active. One or more of the hardware controls 214, 216, or 218 can be optional equipment (e.g., an aftermarket device) that is installed in the EV 202 to generate an emulation input while the emulation operation mode is active.

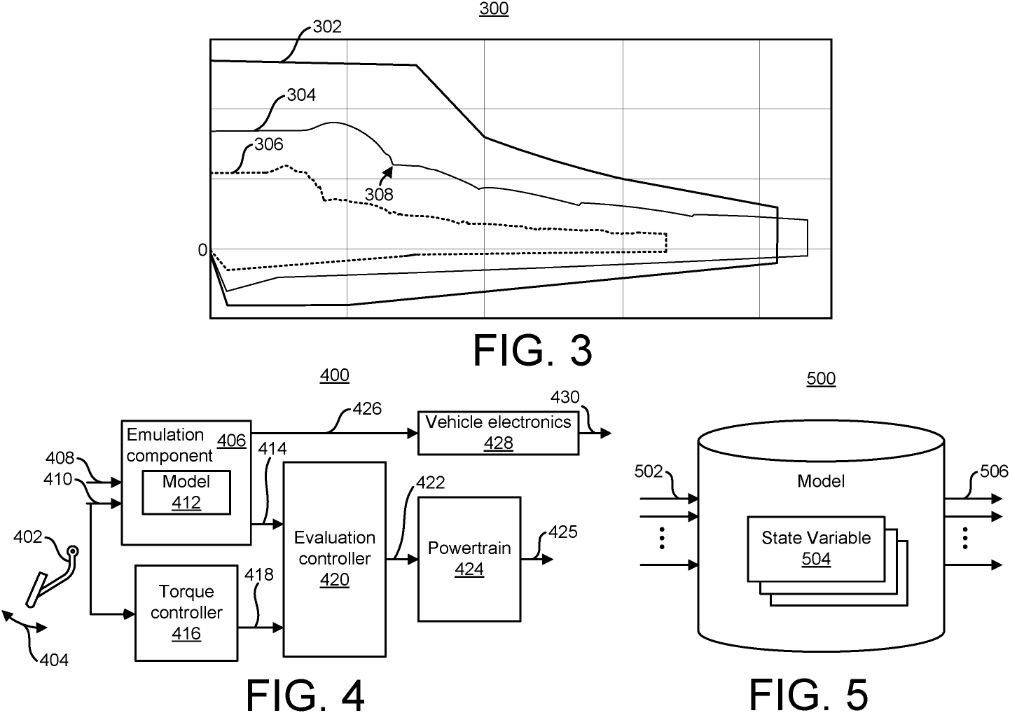

FIG. 3 shows a diagram 300 of an EV acceleration capability encapsulating the acceleration capability of ICE vehicles. The examples of the diagram 300 can be used in combination with one or more other examples described elsewhere herein. The diagram 300 can represent the acceleration capabilities of different vehicle types by visualizing a performance envelope of each one. In the diagram 300, a vertical axis shows longitudinal acceleration of the vehicle (measured in any applicable unit, e.g., in terms of a number of g, the common value of gravitational acceleration). On the vertical axis, the point of zero acceleration is marked. The horizontal axis shows velocity of the vehicle (measured in any applicable unit). As such, the diagram 300 can indicate the available longitudinal acceleration as a function of velocity.

The diagram 300 includes a graph 302 corresponding to a performance EV, a graph 304 corresponding to a midsize ICE automobile sometimes classified as a “pony car,” and a graph 306 corresponding to a lightweight ICE car that can be referred to as a roadster sports car. For example, the performance EV (graph 302) can have multiple electric motors (e.g., permanent-magnet motors) and weigh more than 5,000 lb; the pony car (graph 304) can have a V8 engine and weigh about 3,700 lb; and the roadster (graph 306) can have a four-cylinder engine and weigh about 2,300 lb.

The portions of the graphs 302-306 above zero acceleration represent the abilities of the respective powertrains to accelerate the corresponding vehicle. The performance EV (graph 302) significantly exceeds the acceleration capability of the roadster (graph 306) at any speed, and likewise exceeds the acceleration capability of the pony car (graph 304) at all except the highest speeds (for example, the performance EV may have electronically limited top speed).

The portions of the graphs 302-306 below zero acceleration represent the abilities of the respective powertrains to decelerate the corresponding vehicle. For the performance EV, the negative acceleration may occur by way of regenerative braking upon release of the accelerator pedal, where kinetic energy from the electric motors is converted to electricity that charges the onboard battery. For the pony car and roadster, the negative acceleration may occur as engine braking upon release of the gas pedal, where development of a vacuum inside the ICE depletes kinetic energy from the moving cylinders. The performance EV (graph 302) exceeds the deceleration capability of the roadster (graph 306) at any speed, and likewise exceeds the deceleration capability of the pony car (graph 304) except at the highest speeds.

In some implementations, an emulation algorithm can correspond to a scaled playback of acceleration versus speed. For example, such scaled playback can operate based on one or more of the graphs 302-306 and provide the EV with the corresponding acceleration. For each of the graphs 302-306, the diagram 300 may show one or more points 308 where the slope of the acceleration curve changes significantly. For a vehicle with a multispeed transmission, the points 308 can correspond to gearshifts. If the performance EV in this example has a single-speed transmission, the points 308 in the graph 302 can instead correspond to a boundary between different operational intervals of its powertrain (e.g., regulated by a power electronics controller).

The emulation can have a transient nature. In some implementations, the target acceleration of the EV can be a transient function. For example, a particular input from the driver can trigger the EV to provide acceleration that is a transient response to the input, including, but not limited to, that the transient response can be followed by a steady state response after some amount of time. Examples will now be described with reference to Scenarios A and B according to the respective tables below.

Scenario A

| Characteristic of EV or emulated vehicle | Time | | | |
|---|---|---|---|---|
| | T minus 1 second | T | T plus 1 second | T plus 2 seconds |
| EV accelerator input | 10% | 100% | 100% | 100% |
| EV speed (kilometers per hour) | 100 kph | 100 kph | 102 kph | 115 kph |
| EV acceleration | 0 m/s² | | | |
| Gear of emulated automatic transmission | 6th | 6th→3rd | | |
| Emulated rotations per minute (RPM) | 1800 | | | |
| Emulated turbocharger RPM | 5000 | Accelerates | Accelerates | Full speed |
| Emulated intake absolute pressure (kilopascal) | 30 kPa | 70 kPa | 150 kPa | 250 kPa |
| EV axle torque output (newton-meters) | 500 Nm | Highly variable | 1500 Nm | 2100 Nm |
| Emulated acceleration target | | | +5 m/s² | +7 m/s² |

In the above Scenario A, the driver is making a relatively small accelerator input at T-1 second, and numerical values for some of the characteristics are shown.

At time T, the driver makes a maximum pedal input (pressing the accelerator to the floor). At time T, the EV maintains the speed of 100 kph, with the emulated automatic transmission beginning to downshift to third gear, and the emulated turbocharger accelerating. At time T, the axle torque output can be highly variable to emulate the feeling of a downshift.

At time T+1 second, the driver maintains full throttle and some of the characteristics increase numerically while the turbocharger accelerates and the EV defines an emulated acceleration target of +5 m/s².

At time T+2 seconds, the driver maintains full throttle and some of the characteristics increase numerically while the turbocharger reaches full speed.

Scenario B

| Characteristic of EV or emulated vehicle | Time | |
|---|---|---|
| | T | T plus 5 seconds |
| EV accelerator input | 100% | 100% |
| EV speed (kilometers per hour) | 0 kph | 102 kph |
| EV acceleration | | |
| Gear of emulated automatic transmission | | |
| Emulated rotations per minute (RPM) | | |
| Emulated turbocharger RPM | | Full speed |
| Emulated intake absolute pressure (kilopascal) | | |
| EV axle torque output (newton-meters) | | 2000 Nm |
| Emulated acceleration target | | +7 m/s² |

In the above Scenario B, the driver starts from a stop with full throttle at time T, and numerical values for some of the characteristics are shown.

At time T+5 seconds, the driver maintains full throttle and some of the characteristics increase numerically, including that the emulated turbocharger is already at full speed due to recent history.

In both Scenarios A and B above, the EV reaches 102 kph with full throttle applied. The resultant torques are different from each other due to modeled turbo lag affecting the Scenario A. Transient emulation, of which Scenarios A and B are examples, can have implications for replicating the driver experience, including, but not limited to, with emulating turbocharged cars. An algorithm providing emulation of a transient nature can allow the EV driver to feel the emulated turbo lag as boost build-up, for example as the driver is increasing the amount of throttle coming out of a corner. This example illustrates a level of immersion significantly deeper that emulating full-throttle straight-line acceleration.

That is, the diagram 300 shows that the acceleration performance EV generally encapsulates that of these ICE vehicles (the pony car and the roadster). As such, the performance EV can emulate the acceleration of either of them by applying an acceleration reduction to its native acceleration capability. For example, the acceleration reduction can correspond to the difference between the graph 302 and either of the graphs 304 or 306 at essentially any speed.

FIG. 4 schematically shows an example block diagram of an EV 400. Some aspects of the EV 400 are omitted for simplicity. The EV 400 can be used in combination with one or more other examples described elsewhere herein. The EV 400 includes an accelerator pedal 402 that a driver can depress or release so that it assumes any of a range of positions schematically indicated by an arrow 404 (e.g., the position represented as a percentage of a fully depressed position). In some implementations, the EV 400 emulates the acceleration of one or more ICE vehicle types based at least in part of the present position of the accelerator pedal 402.

The EV 400 includes an emulation component 406 that allows the EV driver to choose between and select any of multiple vehicle types having ICEs, and causes the EV 400 to emulate at least the acceleration of the selected vehicle type. The emulation component 406 can receive an input 408 generated by a user to make the selection (e.g., using the emulation controller 100 in FIG. 1). An input 410 to the emulation component 406 can be generated based on the present position of the accelerator pedal 402. The emulation component 406 can apply the input 410 to a model 412 that corresponds to the vehicle type selected by way of the input 408. The emulation component 406 can output an acceleration value 414 based on the model 412 and the input 410. The acceleration value 414 represents the acceleration that the model 412 specifies for the EV 400 in the present situation. For example, the acceleration value 414 can be essentially any value of the graph 304 (pony car) or graph 306 (roadster) in FIG. 3.

The model 412 can calculate the emulation of the ICE vehicle in any of multiple different ways. The model 412 can take inputs such as accelerator pedal position gear selection, and reactive load, and output the calculated torque and resultant acceleration value. In some implementations, the model 412 scales the pedal input (e.g., acceleration pedal position) as a function of speed (e.g., based on the graph 304 or 306 in FIG. 3. If the EV driver depresses the accelerator pedal 402 by x percent, then the model 412 can output an acceleration value corresponding to the acceleration that the emulated ICE vehicle would undergo, in the applicable gear of its transmission, given an x percent depression of its accelerator pedal. For example, if the acceleration pedal is at 50%, this may correspond to an acceleration of 0.7 g in the EV400 with emulation operation mode inactive, and may correspond to an acceleration of 0.4 g in the emulated ICE vehicle at 50% throttle.

In some implementations, the model 412 can account for the physics of the ICE powertrain. Such aspects can include, but are not limited to, rotational inertia (e.g., the influence of individual moments of inertia of wheels, tires, drive shafts, or other rotating components), transmission gearshifts, turbocharger rotation speed, boost control devices (e.g., controlling air pressure that affects a turbocharger or supercharger), anti-lag systems (e.g., controlling ignition timing to reduce turbo lag), launch control devices (e.g., providing an optimized acceleration using a computer-controlled electronic accelerator), or blow-off valves (e.g., a compressor bypass valve venting to the atmosphere).

The EV 400 can also provide the input 410 to a torque controller 416. The torque controller can be a standard component of the EV powertrain that is not specific to the emulation operation mode. For example, when the emulation operation mode is not active in the EV 400, the input 410 provided to the torque controller 416 can be what causes the EV 400 to operate its powertrain in a particular way in response to the present position of the accelerator pedal 402. The torque controller 416 generates an output that includes an acceleration value 418. That is, the acceleration value 418 represents an acceleration that the EV 400 might have if the emulation operation mode were inactive.

The EV 400 includes an emulation controller 420 that can cap the emulated acceleration with the acceleration specified by the torque controller 416. In some implementations, the emulation controller 420 receives the acceleration value 414 from the emulation component 406, and the acceleration value 418 from the torque controller 416. For example, the emulation controller 420 generate an output 422 corresponding to the lesser of the acceleration value 414 or the acceleration value 418.

The EV 400 can provide the output 422 to a powertrain 424. In some implementations, the powertrain 424 comprises one or more electric motors (e.g., based on induction or permanent magnets) and associated power electronics and control circuitry. The powertrain 424 will generate an acceleration of the EV 400 based on the output 422, as schematically represented by an arrow 425. The present example illustrates emulating an acceleration of an ICE vehicle type without exceeding an associated acceleration of the EV 400 (i.e., by capping the acceleration value 414 by the acceleration value 418.)

The emulation component 406 can generate an output 426 using the model 412. The output 426 can correspond to one or more aspects of emulation other than accelerating the EV 400. In some implementations, the output 426 includes at least one image emulating an instrument cluster of the ICE vehicle. For example, video or another animation showing one or more gauges or dials of the ICE vehicle can be generated. In some implementations, the output 426 includes audio emulating a characteristic of the ICE vehicle. For example, motor sound or non-motor sound can be generated. The EV 400 includes vehicle electronics 428 that receives the output 426 and generates an output 430 that is perceivable by at least the driver of the EV 400. For example, when the output 426 includes imagery, the vehicle electronics 428 can include a display device, and the output 430 can include the visual appearance of the emulated instrument cluster. As another example, when the output 426 includes audio, the vehicle electronics 428 can include a speaker, and the output 430 can include the audible playing of one or more sounds.

Examples described above illustrate that an EV (e.g., the EV 400 in FIG. 4) can include a selection control (e.g., the emulation controller 100 in FIG. 1) to receive a user selection of a first vehicle type from among multiple vehicle types each having an ICE. The user selection is made with regard to an emulation operation mode of the EV (e.g., activated by the input 408 in FIG. 4). The EV can include an accelerator pedal (e.g., the accelerator pedal 402 in FIG. 4) to generate, with the first vehicle type chosen for the emulation operation mode, a first input (e.g., the input 410 in FIG. 4) made by a driver of the EV. The first input is associated with a first acceleration of the EV (e.g., the acceleration value 418 determined by the torque controller 416 in FIG. 4) with the emulation operation mode inactive. The EV can include a model (e.g., the model 412 in FIG. 4) to provide the EV, while the emulation operation mode is active and using a powertrain of the EV (e.g., the powertrain 424 in FIG. 4), with a second acceleration (e.g., corresponding to the output 422 in FIG. 4) determined based on the first vehicle type and the input. The second acceleration is capped by the first acceleration (e.g., using the emulation controller 420 in FIG. 4).

FIG. 5 schematically shows an example block diagram of a model 500 for emulating at least acceleration of an ICE vehicle. The model 500 can be employed for emulating, using a powertrain of an EV that has an emulation operation mode activated, an acceleration of a selected ICE vehicle type without exceeding an associated acceleration of the EV. The model 500 can be used in combination with one or more other examples described elsewhere herein. The model 500 is configured to receive one or more inputs 502. For example, the inputs 502 can include pedal inputs, gearshift requests, or vehicle state information.

The model 500 can include one or more state variables 504. The state variable(s) 504 can be assigned values (e.g., numerical or Boolean values) depending on the input(s) 502. The values of the state variable(s) 504 represent dynamic or static characteristics of the ICE vehicle that is being emulated. Such characteristics can include, but are not limited to, an engine speed (e.g., measured in RPM), a turbo speed (e.g., measured in RPM), a boost pressure, an intake temperature (e.g., the temperature of air entering the ICE), a barometric pressure (e.g., modeled based on an elevation of the current location of the EV), a transmission gear selection (e.g., to affect the available acceleration per the graph 304 or 306 in FIG. 3).

The model 500 can be configured to represent one or more modeled characteristics of the ICE vehicle with which the model 500 is associated. The modeled characteristics can be used to ensure that the EV emulates the feel of the selected ICE vehicle. Such characteristics can include, but are not limited to, component inertia, vehicle mass, volumetric efficiency (e.g., a ratio of a mass density of an air-fuel mixture in the cylinder to that of the same volume of air in the intake), plenum volume (e.g., of an intake manifold), sound (e.g., the sound of an ICE, transmission, or any other audibly perceivable vehicle component), drive-relevant metrics or other signals (e.g., vehicle speed, ICE RPM, ICE temperature, ICE gear selection, ICE air pressure, ICE oil pressure, ICE coolant temperature, turn signal indicator, or ICE fuel level.

The model 500 is configured to generate one or more outputs 506. The output(s) 506 can control one or more aspect of the EV so as to emulate the acceleration and optionally other aspects of the selected ICE vehicle type. Such outputs 506 can include, but are not limited to, a longitudinal acceleration target based on the ICE vehicle, a sound of the ICE vehicle, or an instrument cluster presentation of the ICE vehicle.

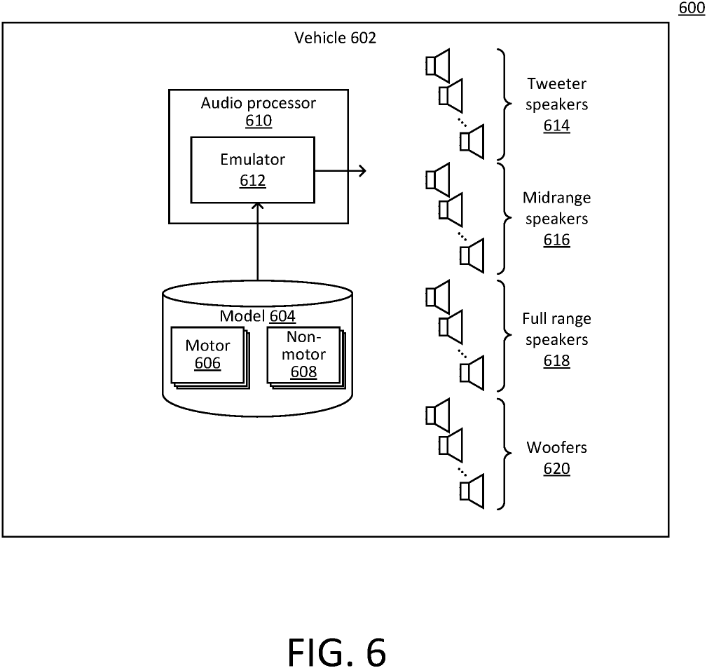

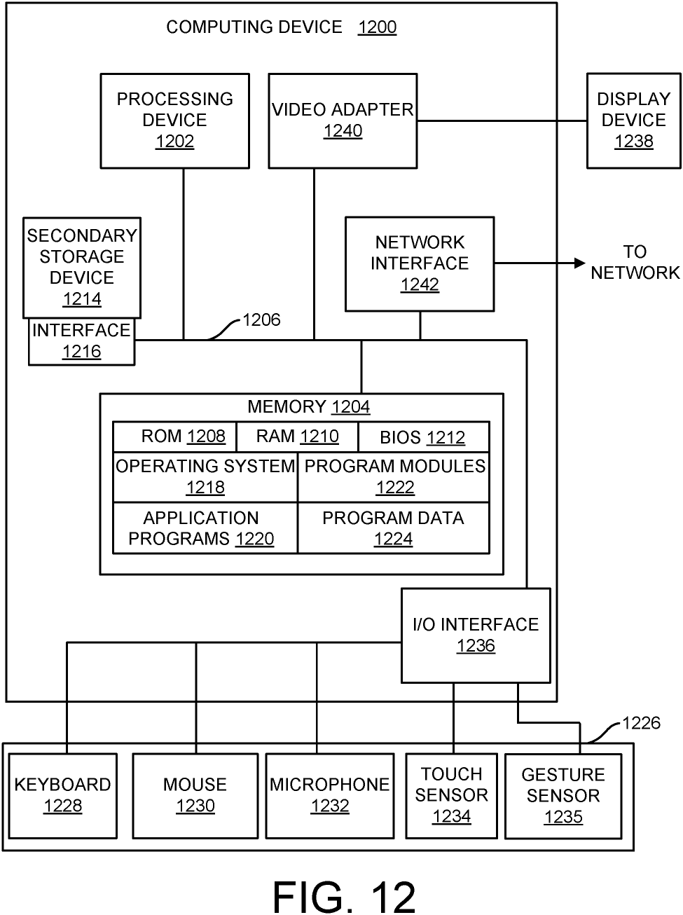

FIG. 6 shows an example of a vehicle audio system 600 that can emulate sounds of an ICE vehicle. The vehicle audio system 600 can be used with one or more other examples described elsewhere herein. The vehicle audio system 600 can be implemented in an EV 602 using some or all examples described below with reference to FIG. 12.

The vehicle audio system 600 includes a model 604 that can represent at least the sound of one or more ICE vehicles. When multiple ICE vehicles are represented, a user can select any of them for emulation. The model 604 can include at least one motor sound 606. In some implementations, the motor sound 606 represents the sound of the powertrain of an ICE (e.g., as perceived inside a passenger cabin of the ICE) at any of multiple different speeds or when idling, ICE RPMs, gear selections, etc. The motor sound 606 can include combustion noise (e.g., exhaust sound or an engine backfire), mechanical sound (e.g., intake noise, transmission noise, or piston slap), or a combination thereof.

The model 604 can include at least one non-motor sound 608. In some implementations, the non-motor sound 608 can relate to any aurally perceivable aspect of the modeled ICE vehicle other than its powertrain. Such aurally perceivable aspect can include, but is not limited to, any of a vehicle horn or other signal mechanism such as a bell, a turn signal indicator, a fan sound, a sound of a parking brake lever being pulled or released, a sound of a windshield wiper, a sound of a manually cranked window, a sound of a door lock, a brake-related sound (e.g., squeaks of disc or drum brakes, or the release of air from a hydraulic braking system), wheel sound (e.g., of particular tire types, or of the metal wheels of a locomotive or another vehicle against rail), or friction sound (e.g., from a vehicle moving through air, or from a watercraft moving through water).

To create the model 604, any of the motor sound 606 or the non-motor sound 608 can be recorded by sampling an actual instance of the ICE vehicle to be modeled, or by synthesizing the real sound. For example, to create the motor sound 606 in a spatially accurate way, data can be gathered with binaural microphones and a head model in the ICE vehicle. The motor sound 606 and/or the non-motor sound 608 can be rendered in three-dimensional (3D) space about the driver so as to realistically emulate the direction from which the sound would naturally reach the driver. For example, exhaust noise can be modeled to arrive generally from a direction where the exhaust pipe(s) terminate on the modeled ICE vehicle. As another example, the sound of a turbo changer or supercharger can arrive from its general location at the ICE.

The sound(s) of the model 604 can be rendered in one or more channels within the EV 602 (e.g., as 3D or “surround” sound, optionally with a height dimension). Any number of channels can be used.

The vehicle audio system 600 can include an audio processor 610 that can receive or obtain from the model 604 any or all of the motor sound 606 or the non-motor sound 608. The audio processor 610 can include a renderer that can be used when playing audio content that has not yet been rendered. In some implementations, the renderer can mix sounds into one or more of the available channels. For example, the renderer can pan sounds between different channels.

The audio processor 610 includes an emulator 612 that can provide audio content of the motor sound 606 or the non-motor sound 608 to one or more speakers to be played. The emulator 612 can be engaged when the emulation operation mode is active and disengaged otherwise. The EV 602 includes speakers for playing audio, including, but not limited to, the motor sound 606 or the non-motor sound 608. One or more types of speaker types can be used, including, but not limited to, tweeter speakers, midrange speakers, full range speakers, and/or woofers. Each speaker (type) can include one or more transducers (e.g., a voice coil) for converting an electric input to sound waves. The EV 602 can include n number of tweeter speakers 614 that can have any of multiple arrangements within the EV 602. The EV 602 can include m number of midrange speakers 616 that can have any of multiple arrangements within the EV 602. The EV 602 can include p number of full range speakers 618 (sometimes referred to as twiddler speakers) that can have any of multiple arrangements within the EV 602. The EV 602 can include q number of woofers 620 (e.g., subwoofers) that can have any of multiple arrangements within the EV 602. Other approaches can be used.

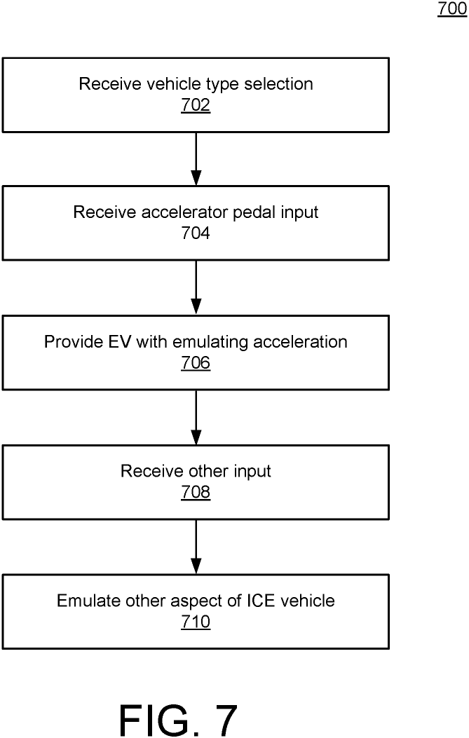

FIG. 7 shows an example of a method 700. The method 700 can be used with one or more other examples described elsewhere herein. More or fewer operations can be performed. Two or more operations can be performed in a different order unless otherwise indicated.

At an operation 702, the method 700 can include receiving, by an EV (e.g., the EV 400 in FIG. 4), a user selection of a first vehicle type from among multiple vehicle types (e.g., the emulation controller 100 in FIG. 1) each having an ICE. The user selection is made with regard to an emulation operation mode of the EV (e.g., activated by the input 408 in FIG. 4).

At an operation 704, the method 700 can include receiving, by the EV and with the first vehicle type selected for the emulation operation mode, a first input (e.g., the input 410 in FIG. 4) made by a driver using an accelerator pedal of the EV. The first input is associated with a first acceleration of the EV (e.g., the acceleration value 418 determined by the torque controller 416 in FIG. 4) with the emulation operation mode inactive.

At an operation 706, in response to the input and while the emulation operation mode is active, the method can include providing the EV with a second acceleration (e.g., corresponding to the output 422 in FIG. 4) determined based on the first vehicle type and the input. The second acceleration is capped by the first acceleration (e.g., using the emulation controller 420 in FIG. 4). For example, sound of the ICE can also be emulated.

At an operation 708, the method 700 can include receiving another input. In some implementations, the other input can be generated using a hardware control of the EV. For example, the other input can represent a gearshift request, configuration of the ICE powertrain (e.g., engagement or disengagement of a component), or use of any other component in the EV that may be associated with visual output or sound.

At an operation 710, the method 700 can include emulating another aspect of the ICE vehicle. In some implementations, the emulation can be performed in response to the input in the operation 708. For example, if the EV driver switched to another modeled ICE powertrain, or reconfigured the modeled ICE powertrain, the emulation at the operation 710 can take the change(s) into account.

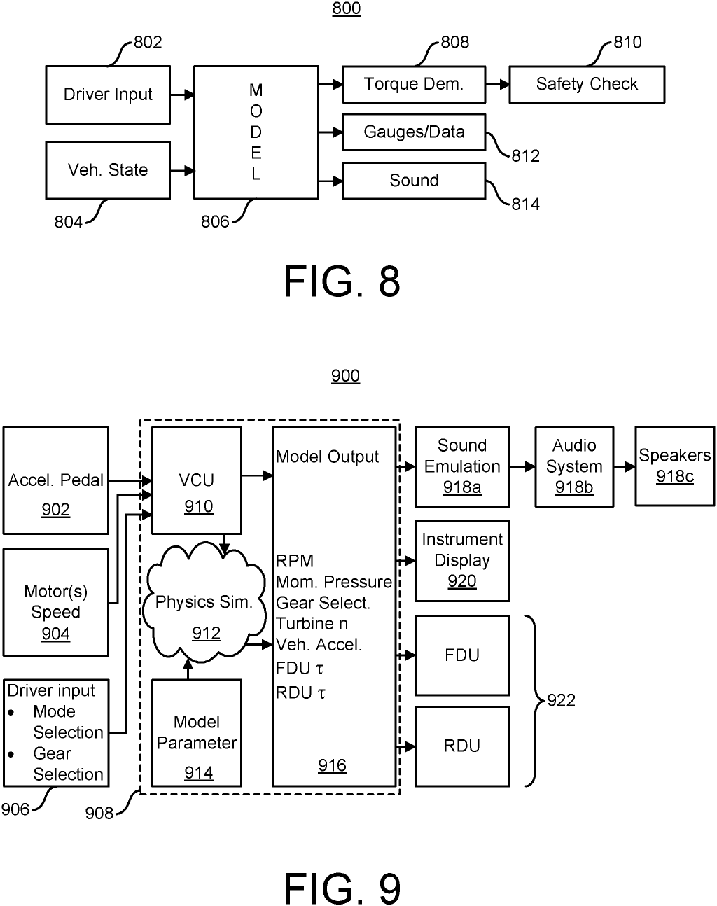

FIG. 8 shows an example of a system 800 that can perform emulation in an EV. The system 800 can be used with one or more other examples described elsewhere herein. The system 800 includes a driver input 802. In some implementations, the driver input 802 is generated by a driver using one or more hardware controls of an EV. For example, the driver input 802 can be generated using one or more of an accelerator pedal, brake pedal, clutch pedal, gear shifter/selector, knob, wheel, button, lever, crank, pull, control stalk, paddle, toggle, scroll wheel, or other physical control device.

The system 800 includes a vehicle state 804. In some implementations, the vehicle state 804 comprises information (e.g., digital information represented in electronic form as one or more signals) representing one or more aspects of a current state of the EV. For example, the vehicle state 804 can include, or be based on, the output of one or more components (e.g., motor, gearbox, electronic control unit, or sensor) corresponding to one or more aspects of a present characteristic of the EV.

The driver input 802 and the vehicle state 804 can be input to a model 806. In some implementations, the model 806 can include hardware and/or software and can be designed or configured to emulate, in the EV where the system 800 is currently being used, one or more aspects of another vehicle than the EV.

The model 806 can generate one or more outputs based on the driver input 802 and the vehicle state 804. In some implementations, the model 806 can generate a torque demand 808 that corresponds to an emulation of the acceleration of the other vehicle. The torque demand 808 can be subjected to a safety check 810. The safety check 810 can ensure that the emulation acceleration of the EV is capped by an acceleration that the EV would undergo in this situation if the emulation operation mode were inactive. For example, assume that the EV had the emulation operation mode inactive and would provide at most an acceleration a m/s² in the present situation with the driver input 802 and the vehicle state 804 otherwise being the same. The emulation acceleration can then presently be capped to a m/s² to avoid subjecting the driver to a greater acceleration than what the EV would otherwise provide.

In some implementations, the model 806 can generate output 812 for one or more gauges or other output devices. The output 812 can include information to affect the operation of one or more components of the EV whose functionality may be perceivable by the driver as an emulation. For example, the output 812 can affect a presentation on one or more display devices of the EV.

In some implementations, the model 806 can generate sound 814. The sound 814 can include digital and/or analog audio signals for at least one speaker in the EV whose output may be perceivable by the driver as an emulation. For example, the sound of a combustion-engine powertrain can be emulated.

FIG. 9 shows an example of an architecture 900 for performing emulation in an EV. The architecture 900 can be used with one or more other examples described elsewhere herein. The architecture 900 can include an accelerator pedal input 902 that the driver generates using an acceleration pedal of the EV. The architecture 900 can include a motor speed input 904 reflecting the speed of one or more electric motors of the EV. The architecture 900 can include a driver input 906. In some implementations, the driver input 906 can reflect whether emulation operation mode is currently active or inactive. In some implementations, the driver input 906 can reflect an operating mode of the EV, including but not limited to, an operating mode of the EV powertrain. In some implementations, the driver input 906 can reflect a gear selection by the driver. Other driver inputs, choices, selections, settings, activations, or deactivations can also or instead be reflected by the driver input 906.

The accelerator pedal input 902, motor speed input 904, and/or driver input 906 can be received in a processing component 908 (e.g., implemented using a processor and at least one memory or other computer-readable storage) of the EV. The processing component 908 can use one or more of the accelerator pedal input 902, motor speed input 904, and/or driver input 906 to provide emulation of another vehicle. For example, the processing component 908 can include a vehicle control unit 910 that is implemented in form of one or more processors and can control one or more aspects of the EV’s functionality. In some implementations, the processing component 908 includes a physics simulator 912. The physics simulator 912 can include hardware and/or software and can be designed or configured to simulate one or more physical characteristics or circumstances based on some or all parameters currently known by the processing component 908. The physics simulator 912 can model the performance characteristics of the emulated vehicle for the purpose of controlling the EV so as to emulate that behavior. For example, acceleration and/or other dynamics can be modeled. The physics simulator 912 can make use of one or more parameters of model parameters 914 in performing its simulation.

The physics simulator 912 can generate a model output 916 based on its simulation. The model output 916 can include one or more values, states, characteristics, symbols, or other information reflecting an aspect or characteristic of the emulated vehicle. The model output 916 can reflect one or more of, but is not limited to, motor RPM, momentaneous air pressure, gear selection, turbine pressure/speed, vehicle acceleration, or motor torque (e.g., for each of multiple drive units).

The processing component 908 can generate one or more outputs based on the physics simulator 912. In some implementations, the output can include a sound emulation 918a that is provided to one or more speakers of the EV. For example, the sound emulation 918a can emulate the sound of an ICE powertrain under the current operating conditions (e.g., speed, acceleration, gear selection). The sound emulation 918a can be provided to an audio system 918b (e.g., a multi-channel surround sound system that can play sound localized in three dimensions). The audio system 918b can output audio based on the sound emulation 918a in one or more individual units of speakers 918c in the EV.

In some implementations, the output can include an instrument display emulation 920. For example, the instrument display emulation 920 can include at least one image (e.g., a video stream) that emulates one or more aspects of an instrument panel of the vehicle being emulated.

In some implementations, the output can include a motor control signal 922 for the motor(s) of the EV. For example, the motor control signal 922 can include respective signals configured for two or more electric motors of the EV (e.g., a front drive unit (FDU) and/or a rear drive unit (RDU)).

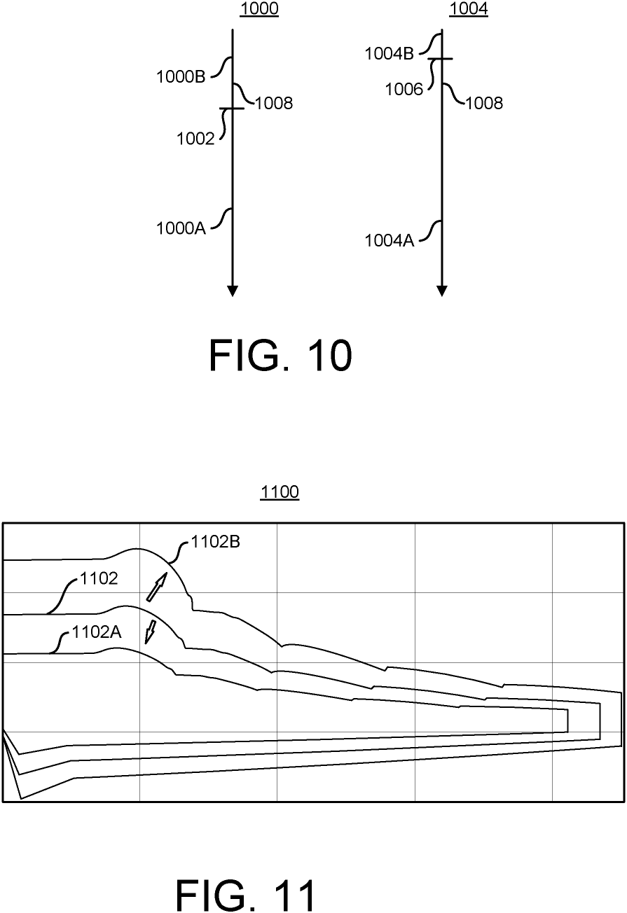

FIG. 10 schematically shows emulation of torque crossover. An axis 1000 represents positions of an EV accelerator pedal (e.g., controlled by the driver’s foot). The features of the axis 1000 can be used together with one or more other examples described elsewhere herein. The axis 1000 can represent the accelerator pedal input using a suitable metric, such as the current pedal position relative to a maximum pedal input. For example, no pedal input (i.e., 0% of the maximum pedal input) can correspond to a position at the upper end of the axis 1000, and full pedal input (i.e., 100% of the maximum pedal input) can correspond to a position at the lower end of the axis 1000.

The availability of regenerative braking in the EV can be reflected in the axis 1000. In an EV traveling at speed, accelerator pedal positions greater than a certain value can correspond to positive torques, and accelerator pedal positions smaller than the certain value can correspond to regenerative braking. An EV torque crossover 1002 is here schematically indicated and is associated with a pedal input greater than 0% and smaller than 100% of the maximum. A portion 1000A of the axis 1000 corresponding to more pedal input than the EV torque crossover 1002 is indicated, and so is a portion 1000B of the axis 1000 corresponding to less pedal input than the EV torque crossover 1002. Positive acceleration (i.e., positive torque) may occur when the EV accelerator pedal position is within the portion 1000A. Regenerative braking (i.e., negative torque) may occur when the EV accelerator pedal position is within the portion 1000B. That is, the torque crosses over between negative and positive at the EV torque crossover 1002. When emulation operation mode is not active, the location of the EV torque crossover 1002 can change as a function of the speed of the EV.

The vehicle that is being emulated, on the other hand, may not have regenerative braking, or may have a different torque crossover than the EV. An axis 1004 represents positions of an accelerator pedal of the emulated vehicle. Similar to the above example, a torque crossover 1006 is here schematically indicated. The torque crossover 1006 is associated with a pedal input greater than 0% and smaller than 100% of the maximum but is different from the EV torque crossover 1002. A portion 1004A of the axis 1004 corresponding to more pedal input than the torque crossover 1006 is indicated, and so is a portion 1004B of the axis 1004 corresponding to less pedal input than the torque crossover 1006.

In the EV, with emulation operation mode being inactive, a pedal position 1008 in the portion 1000B, such as about 5%, can correspond to, say, 1 m/s² of deceleration at a certain speed. On the axis 1004 of the emulated powertrain, by contrast, the pedal position 1008 can correspond to a very small positive acceleration. As such, the positivity or negativity of acceleration can sometimes differ between the emulated powertrain and the EV powertrain. If the EV is configured for capping of the emulated acceleration, such capping can be deactivated or modified under certain circumstances (e.g., based on a magnitude of the emulated acceleration). For example, the capping can be performed only when the emulated acceleration is greater than an upper limit (e.g., 2 m/s²), and/or the capping can be performed only when the emulated deceleration is smaller than a lower limit (e.g., -3 m/s²).

FIG. 11 shows examples of scaling in an emulation. The examples are shown by a diagram 1100 of EV acceleration, in which a vertical axis shows longitudinal acceleration of the vehicle (measured in any applicable unit, e.g., in terms of a number of g, the common value of gravitational acceleration), and a horizontal axis shows velocity of the vehicle (measured in any applicable unit). The examples of the diagram 300 can be used in combination with one or more other examples described elsewhere herein.

A graph 1102 in the diagram 1100 here represents the acceleration capacity of the emulated vehicle. This acceleration, at the respective speeds of the diagram 1100, may be greater (or smaller) than the acceleration capacity of the EV that is to perform the emulation. In some implementations, the EV can perform emulation based on a scaling of the graph 1102 in one or more of its regions (e.g., as a calibration performed by a scaling algorithm that is part of the model for the emulated vehicle(s)). For example, a graph 1102A here represents a scaling down of the graph 1102. Humans may not be good at detecting absolute acceleration, so scaling down the acceleration of the emulated vehicle can provide the essence of the emulation experience. As another example, a graph 1102B here represents a scaling up of the graph 1102. As such, the emulation implementation can include a scaling algorithm that is used to appropriately scale the powertrain’s torque output to fit the capabilities of the EV.

FIG. 12 illustrates an example architecture of a computing device 1200 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 12 can be used to execute the operating system, application programs, and/or software modules (including the software engines) described herein.

The computing device 1200 includes, in some embodiments, at least one processing device 1202 (e.g., a processor), such as a central processing unit (CPU). A variety of processing devices are available from a variety of manufacturers, for example, Intel or Advanced Micro Devices. In this example, the computing device 1200 also includes a system memory 1204, and a system bus 1206 that couples various system components including the system memory 1204 to the processing device 1202. The system bus 1206 is one of any number of types of bus structures that can be used, including, but not limited to, a memory bus, or memory controller; a peripheral bus; and a local bus using any of a variety of bus architectures.

Examples of computing devices that can be implemented using the computing device 1200 include a desktop computer, a laptop computer, a tablet computer, a mobile computing device (such as a smart phone, a touchpad mobile digital device, or other mobile devices), or other devices configured to process digital instructions.

The system memory 1204 includes read only memory 1208 and random access memory 1210. A basic input/output system 1212 containing the basic routines that act to transfer information within computing device 1200, such as during start up, can be stored in the read only memory 1208.

The computing device 1200 also includes a secondary storage device 1214 in some embodiments, such as a hard disk drive, for storing digital data. The secondary storage device 1214 is connected to the system bus 1206 by a secondary storage interface 1216. The secondary storage device 1214 and its associated computer readable media provide nonvolatile and non-transitory storage of computer readable instructions (including application programs and program modules), data structures, and other data for the computing device 1200.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 1214 and/or system memory 1204, including an operating system 1218, one or more application programs 1220, other program modules 1222 (such as the software engines described herein), and program data 1224. The computing device 1200 can utilize any suitable operating system.

In some embodiments, a user provides inputs to the computing device 1200 through one or more input devices 1226. Examples of input devices 1226 include a keyboard 1228, mouse 1230, microphone 1232 (e.g., for voice and/or other audio input), touch sensor 1234 (such as a touchpad or touch sensitive display), and gesture sensor 1235 (e.g., for gestural input). In some implementations, the input device(s) 1226 provide detection based on presence, proximity, and/or motion. Other embodiments include other input devices 1226. The input devices can be connected to the processing device 1202 through an input/output interface 1236 that is coupled to the system bus 1206. These input devices 1226 can be connected by any number of input/output interfaces, such as a parallel port, serial port, game port, or a universal serial bus. Wireless communication between input devices 1226 and the input/output interface 1236 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 1238, such as a monitor, liquid crystal display device, light-emitting diode display device, projector, or touch sensitive display device, is also connected to the system bus 1206 via an interface, such as a video adapter 1240. In addition to the display device 1238, the computing device 1200 can include various other peripheral devices (not shown), such as speakers or a printer.

The computing device 1200 can be connected to one or more networks through a network interface 1242. The network interface 1242 can provide for wired and/or wireless communication. In some implementations, the network interface 1242 can include one or more antennas for transmitting and/or receiving wireless signals. When used in a local area networking environment or a wide area networking environment (such as the Internet), the network interface 1242 can include an Ethernet interface. Other possible embodiments use other communication devices. For example, some embodiments of the computing device 1200 include a modem for communicating across the network.

The computing device 1200 can include at least some form of computer readable media. Computer readable media includes any available media that can be accessed by the computing device 1200. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 12 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 1200 can be characterized as an ADAS computer. For example, the computing device 1200 can include one or more components sometimes used for processing tasks that occur in the field of artificial intelligence (AI). The computing device 1200 then includes sufficient proceeding power and necessary support architecture for the demands of ADAS or AI in general. For example, the processing device 1202 can include a multicore architecture. As another example, the computing device 1200 can include one or more co-processors in addition to, or as part of, the processing device 1202. In some implementations, at least one hardware accelerator can be coupled to the system bus 1206. For example, a graphics processing unit can be used. In some implementations, the computing device 1200 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or subcombinations of the functions, components and/or features of the different implementations described.

What is claimed is:

1. A computer-implemented method comprising:
receiving, by an electric vehicle (EV), a user selection of a first vehicle type from among multiple vehicle types each having an internal combustion engine, the user selection made with regard to an emulation operation mode of the EV;
receiving, by the EV and with the first vehicle type selected for the emulation operation mode, a first input made by a driver using an accelerator pedal of the EV, the first input associated with a first acceleration of the EV with the emulation operation mode inactive; and
in response to the first input and while the emulation operation mode being active, providing the EV with a second acceleration determined based on the first vehicle type and the first input.

2. The computer-implemented method of claim 1, wherein providing the EV with the second acceleration comprises emulating an acceleration of the first vehicle type.

3. The computer-implemented method of claim 2, wherein emulating the acceleration of the first vehicle type comprises applying an acceleration reduction to the EV.

4. The computer-implemented method of claim 2, wherein emulating the acceleration of the first vehicle type comprises taking into account at least one characteristic of the first vehicle type selected from the group consisting of: rotational inertia, transmission gearshifts, turbocharger rotation speed, boost control, anti-lag control, launch control, or a blowoff valve.

5. The computer-implemented method of claim 2, wherein emulating the acceleration of the first vehicle type comprises emulating gearshifts of the first vehicle type.

6. The computer-implemented method of claim 2, wherein emulating the acceleration of the first vehicle type comprises applying at least the first input to a model corresponding to the first vehicle type.

7. The computer-implemented method of claim 1, further comprising emulating, on a display device of the EV, an instrument cluster of the first vehicle type.

8. The computer-implemented method of claim 1, further comprising emulating, using a speaker of the EV, a sound of the first vehicle type.

9. The computer-implemented method of claim 8, wherein the sound of the first vehicle type includes a motor sound.

10. The computer-implemented method of claim 8, wherein the sound of the first vehicle type includes a non-motor sound.

11. The computer-implemented method of claim 1, further comprising receiving a second input in the EV, and applying the second input in emulating the first vehicle type.

12. The computer-implemented method of claim 11, wherein the second input includes a gearshift request made using a hardware control of the EV, and wherein applying the second input in emulating the first vehicle type comprises adjusting the second acceleration based on the second input.

13. The computer-implemented method of claim 1, wherein the first vehicle type is a track vehicle.

14. The computer-implemented method of claim 1, wherein the first vehicle type is a non-road vehicle.

15. The computer-implemented method of claim 1, further comprising capping the second acceleration by the first acceleration at least once.

16. The computer-implemented method of claim 15, wherein the second acceleration is capped by the first acceleration in response to a magnitude of the second acceleration exceeding a limit.

17. The computer-implemented method of claim 1, wherein the second acceleration is based on a scaling of an acceleration capability of the first vehicle type.

18. The computer-implemented method of claim 1, wherein providing the EV with the second acceleration comprises changing a torque crossover.

19. An electric vehicle (EV) comprising:
a selection control to receive a user selection of a first vehicle type from among multiple vehicle types each having an internal combustion engine, the user selection made with regard to an emulation operation mode of the EV;
an accelerator pedal to generate, with the first vehicle type chosen for the emulation operation mode, a first input made by a driver of the EV, the first input associated with a first acceleration of the EV with the emulation operation mode inactive; and
a model to provide the EV, while the emulation operation mode is active and using a powertrain of the EV, with a second acceleration determined based on the first vehicle type and the first input.

20. The EV of claim 19, further comprising a display device, wherein the model outputs an image that emulates an instrument cluster of the first vehicle type.

21. The EV of claim 19, further comprising a speaker, wherein the model outputs audio that emulates a sound of the first vehicle type.

22. The EV of claim 19, further comprising a hardware control for the driver to make a gearshift request, wherein the model adjusts the second acceleration based on the gearshift request.

23. The EV of claim 19, wherein the model has inputs including acceleration pedal input, gearshift requests, and vehicle state, and wherein the model generates outputs including a longitudinal acceleration target, sound, and driver metrics.

24. The EV of claim 19, wherein the second acceleration is capped by the first acceleration at least once.

25. The EV of claim 24, wherein the second acceleration is capped by the first acceleration in response to a magnitude of the second acceleration exceeding a limit.

26. An electric vehicle (EV) comprising:
a selection control to receive a user selection of a first vehicle type from among multiple vehicle types each having an internal combustion engine, the user selection made with regard to an emulation operation mode of the EV;
a powertrain; and
means for emulating, using the powertrain and while the emulation operation mode is active, an acceleration of the first vehicle type without exceeding an associated acceleration of the EV.
